(19) United States
(12) Patent Application Publication
(10) Pub. No.: US 2010/0321461 A1
(43) Pub. Date: Dec. 23, 2010

(54) OPTICAL SCANNER AND IMAGE FORMING APPARATUS INCLUDING SAME

(76) Inventors: Katsunori SHOJI, Chigasaki-shi (JP); Susumu NARITA, Kawasaki-shi (JP)

Correspondence Address: DICKSTEIN SHAPIRO LLP, 1825 EYE STREET NW, Washington, DC, 20006-5403, US

(21) Appl. No.: 12/796,331

(22) Filed: Jun. 8, 2010

(30) Foreign Application Priority Data
Jun. 19, 2009 (JP) 2009-146774

(51) Int. Cl. B41J 2/435; G02B 26/08

(52) U.S. Cl. 347/224; 359/205.1

(57) ABSTRACT

An optical scanner includes a rotation control unit to change a number of revolutions of a rotary deflector to change a ratio of a scan speed of a light beam scanned on the surface of a latent image bearing member to a linear velocity of the latent image bearing member in accordance with a change in a linear velocity of the latent image bearing member, an inclination adjustment unit to adjust inclination of a scan line relative to a reference scan line on the latent image bearing member, an inclination adjustment unit controller to adjust the inclination adjustment unit based on the ratio, and a scan initiation unit to initiate scanning of the light beam on the surface of the latent image bearing member after adjustment of inclination is completed and the rotary deflector starts rotating at a constant speed for writing a latent image.

### CROSS-REFERENCE TO RELATED APPLICATIONS

This patent application is based on and claims priority pursuant to 35 U.S.C. §119 from Japanese Patent Application No. 2009-146774, filed on Jun. 19, 2009 in the Japan Patent Office, which is hereby incorporated herein by reference in its entirety.

### BACKGROUND OF THE INVENTION

1. Field of the Invention

Exemplary aspects of the present invention generally relate to an optical scanner and an image forming apparatus, such as a printer, a digital copier, and a facsimile machine, using the optical scanner.

2. Description of the Background Art

Typically, image forming apparatuses such as a printer, a copier, and a facsimile are equipped with an optical scanner to form an electrostatic latent image on a latent image bearing member, for example, a photoreceptor. Such an optical scanner includes a light source that projects a light beam against a rotary deflector that deflects the light beam onto the latent image bearing member. The light beam projected from the light source and deflected by the rotary deflector exposes and scans the photoreceptor to form the latent image thereon.

The latent image is developed with toner into a visible image, also known as a toner image, by a developing device. Subsequently, the toner image is transferred onto a recording medium and fixed thereon. The recording medium on which the image is fixed is then discharged outside the image forming apparatus.

With image forming apparatuses, there is market demand for accommodation of various types of recording media sheets with different thicknesses, insofar as fixing a toner image on a relatively thick recording medium requires a relatively large amount of heat compared to fixing the same toner image on an ordinary recording medium.

In attempting to accommodate recording media sheets of different thicknesses, in one approach, when fixing a toner image on a relatively thick recording medium, an amount of heat per unit of time is increased by reducing a process linear velocity such as a speed of rotation of the photoreceptor, thereby decreasing a printing speed and consequently increasing exposure of the toner-bearing medium to the heat to achieve a desired fixing performance.

Changing the process linear velocity of the photoreceptor necessitates changing a number of revolutions Rm of the rotary deflector of the optical scanner. The number of revolutions Rm can be expressed by the following equation:

Rm=(60×ρ×V)/(25.4×M×N), EQUATION (1)

where V is a linear velocity [mm/s] of the photoreceptor, N is a number of light beams projected against the surface of the photoreceptor, ρ is a pixel density [dpi] (dot/inch), and M is a number of reflective faces of the rotary deflector.

By adjusting the number of revolutions Rm of the rotary deflector to satisfy EQUATION 1, even when the linear velocity V of the photoreceptor fluctuates the light beam can properly scan the photoreceptor without causing the pixel density to fluctuate in a sub-scanning direction (a direction of movement of the photoreceptor).

As can be understood from EQUATION 1, for a given M (the number of reflective surfaces of the rotary deflector), a given N (the number N of light beams illuminating the surface of the photoreceptor), and a constant ρ (the pixel density [dpi] (dot/inch)), the linear velocity V of the photoreceptor and the number of revolutions Rm of the rotary deflector are proportional. Furthermore, a scan speed Vimg of the light beam that scans the surface of the photoreceptor is also proportional to the number of revolutions Rm of the rotary deflector.

Therefore, when M, N, and p are constant, a ratio K of the linear velocity V to a scan speed Vimg (K=V/Vimg) is constant. Thus, even when the linear velocity V of the photoreceptor fluctuates, the scan line is prevented from getting inclined by adjusting the number of revolutions Rm of the rotary deflector to satisfy EQUATION 1.

However, there is a drawback to this approach in that if the number of revolutions Rm of the rotary deflector is fewer than a certain critical lower threshold speed, a polygon motor that drives the rotary deflector does not operate stably, resulting in irregular rotation of the rotary deflector.

To address such a difficulty, when the linear velocity V of the photoreceptor falls under a predetermined speed, in JP-2007-293202-A the optical scanner reduces the number of light beams so that the number of revolutions of the rotary deflector remains within a number of revolutions that the polygon motor can accommodate. However, reducing the number N of light beams causes the ratio K of the linear velocity V of the photoreceptor to the scan speed Vimg of the scan line (K=V/Vimg) to fluctuate, resulting in inclination of the scan line.

To counteract this difficulty, JP-2008-233151-A includes an inclination adjustment mechanism that adjusts the inclination of the scan line in accordance with the ratio K of the linear velocity V of the photoreceptor to the scan speed Vimg of the scan line (K=V/Vimg) when the ratio K fluctuates. With this configuration, the scan line is prevented from shifting even when the ratio K fluctuates.

In this related-art optical scanner, when the rotary deflector rotates at a constant speed (hereinafter also referred to as “polygon lock status”) at the number of revolutions Rm and its rotation is detected, printing is started, that is, the light beams start scanning the photoreceptor.

In this approach, the timing of driving the rotary deflector is configured such that the polygon lock status starts after inclination is adjusted, that is, the rotary deflector starts to rotate at a constant speed.

Although advantageous, this approach also has a drawback. In this approach, when the polygon lock status is detected, printing is initiated. That is, based on a rise time for the stationary rotary deflector to start rotating at the prescribed number of revolutions Rm, the timing with which the rotary deflector starts to be driven is set such that the polygon lock status starts after adjustment of inclination of the scan line.

In this approach, however, even when operation of the rotary deflector is stopped, the rotary deflector continues rotating through inertia, thereby causing the scan line to incline when there is a print instruction that causes the ratio K to change. This is because rotation of the rotary deflector is initiated while the rotary deflector is still rotating through inertia. As a result, the rotary deflector can start rotating at a constant speed at the prescribed number of revolutions Rm earlier than when rotation of the stationary rotary deflector is initiated. Thus, the polygon lock status is detected before completion of the adjustment of inclination of the scan line, and printing is initiated, accordingly. In such a case, even after printing is started, the scan line still gets adjusted, resulting in undesirable inclination of the scan line.

On the other hand, if the drive timing of the rotary deflector is delayed when the rise time for the rotary deflector is relatively short, the time from which adjustment of shift is completed until the polygon lock status is detected is relatively long. As a result, there is a problem in which downtime, that is, the time from which printing is instructed until printing is actually started, is relatively long.

In view of the above, an optical scanner capable of projecting light beams onto the photoreceptor after adjustment of inclination of the scan line while reducing downtime is required.

### SUMMARY OF THE INVENTION

In view of the foregoing, in one illustrative embodiment of the present invention, an optical scanner includes a light projector, a rotary deflector, a rotation control unit, an inclination adjustment unit, an inclination adjustment unit controller, and a scan initiation unit. The light projector projects a light beam. The rotary deflector deflects the light beam against a latent image bearing member to scan the latent image bearing member in a main scanning direction. The rotation control unit changes a number of revolutions of the rotary deflector to change a ratio of a scan speed of the light beam scanning the surface of the latent image bearing member to a linear velocity of the latent image bearing member as the linear velocity of the latent image bearing member changes. The inclination adjustment unit adjusts inclination of a scan line relative to a reference scan line on the latent image bearing member. The inclination adjustment unit controller adjusts the inclination adjustment unit based on the ratio to prevent the scan line from being inclined relative to the reference scan line. The scan initiation unit initiates scanning of the surface of the latent image bearing member by the light beam after adjustment of inclination by the inclination adjustment unit is completed and the rotary deflector starts rotating at a constant speed for writing the latent image on the surface of the latent image bearing member.

In another illustrative embodiment of the present invention, a method of scanning a light beam includes projecting a light beam, deflecting the light beam against a latent image bearing member to scan the latent image bearing member in a main scanning direction, changing a number of revolutions of the rotary deflector to change a ratio of a scan speed of the light beam scanning the surface of the latent image bearing member to a linear velocity of the latent image bearing member as the linear velocity of the latent image bearing member changes, adjusting inclination of a scan line relative to a reference scan line on the latent image bearing member, adjusting the adjusting inclination based on the ratio to prevent the scan line from being inclined relative to the reference scan line, and initiating scanning of the surface of the latent image bearing member by the light beam after adjustment of inclination and after the rotary deflector starts rotating at a constant speed for writing the latent image on the surface of the latent image bearing member.

Additional features and advantages of the present invention will be more fully apparent from the following detailed description of illustrative embodiments, the accompanying drawings and the associated claims.

### BRIEF DESCRIPTION OF THE DRAWINGS

A more complete appreciation of the disclosure and many of the attendant advantages thereof will be readily obtained as the same becomes better understood by reference to the following detailed description of illustrative embodiments when considered in connection with the accompanying drawings, wherein:

FIG. 1 is a schematic diagram illustrating a printer as an example of an image forming apparatus according to an illustrative embodiment of the present invention;

FIG. 2 is a schematic cross-sectional view of an optical scanner according to an illustrative embodiment of the present invention;

FIG. 3 is a schematic diagram illustrating the optical scanner of FIG. 2 as viewed from the bottom thereof;

FIG. 4 is a diagram for explaining an inclination of scan lines caused by a change in a ratio K of linear velocity V to scan speed Vimg;

FIGS. 5A and 5B are diagrams for explaining an inclination of scan lines caused by a change in the ratio K when using an optical scanner of an opposed scanning type according to an illustrative embodiment of the present invention;

FIGS. 6A and 6B are perspective schematic diagrams illustrating a scan lens unit employed in the optical scanner according to an illustrative embodiment of the present invention;

FIG. 7 is a block diagram illustrating a portion of an electric circuit of the optical scanner according to an illustrative embodiment of the present invention;

FIG. 8 is a block diagram illustrating a control unit 200 according to an illustrative embodiment of the present invention;

FIG. 9 is a flowchart illustrating an exemplary procedure of inclination adjustment according to an illustrative embodiment of the present invention; and

FIG. 10 is a perspective schematic view of a portion of an intermediate transfer belt and an optical sensor assembly according to an illustrative embodiment of the present invention.

### DETAILED DESCRIPTION OF ILLUSTRATIVE EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

In a later-described comparative example, illustrative embodiment, and alternative example, for the sake of simplicity the same reference numerals will be given to constituent elements such as parts and materials having the same functions, and redundant descriptions thereof omitted.

Typically, but not necessarily, paper is the medium from which is made a sheet on which an image is to be formed. It should be noted, however, that other printable media are available in sheet form, and accordingly their use here is included. Thus, solely for simplicity, although this Detailed Description section refers to paper, sheets thereof, paper feeder, etc., it should be understood that the sheets, etc., are not limited only to paper, but includes other printable media as well.

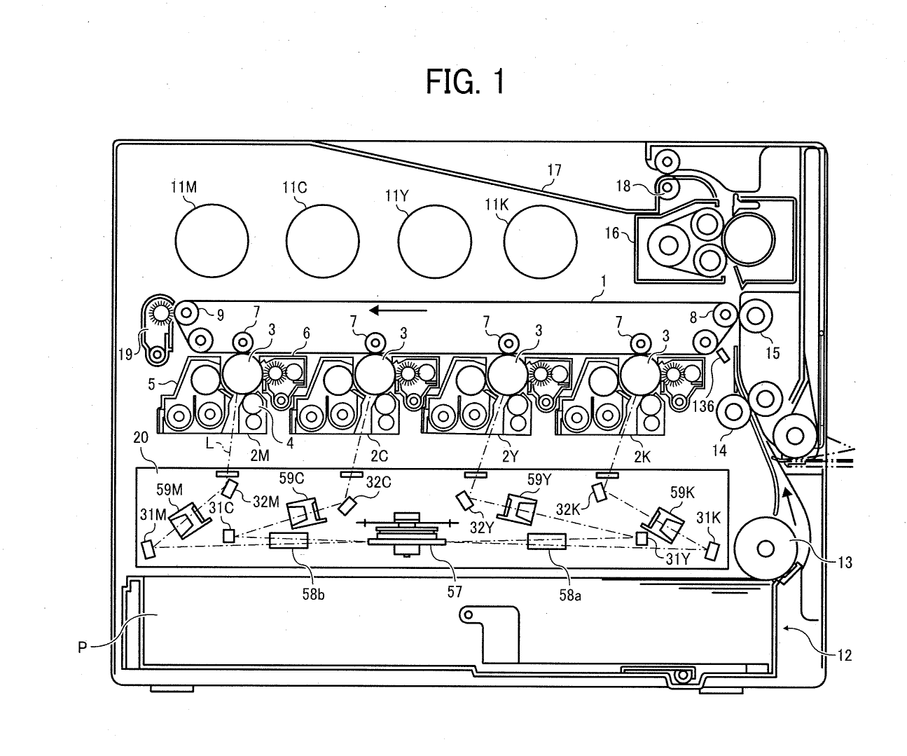

Referring now to the drawings, wherein like reference numerals designate identical or corresponding parts throughout the several views, and initially to FIG. 1, one example of an image forming apparatus according to an illustrative embodiment of the present invention is described.

FIG. 1 is a schematic diagram illustrating an electrophotographic color laser printer as an example of the image forming apparatus according to the illustrative embodiment of the present invention.

In FIG. 1, the image forming apparatus includes an intermediate transfer belt 1, four image forming units 2M, 2C, 2Y, and 2K, an opposed scanning-type optical scanner 20, a sheet feed cassette 12, a sheet feed mechanism 13, a pair of registration rollers 14, a secondary transfer roller 15, a fixing unit 16, a sheet discharge tray 17, a sheet discharge roller 18, and so forth. It is to be noted that reference characters M, C, Y, and K denote colors magenta, cyan, yellow, and black, respectively.

The four image forming units 2M, 2C, 2Y, and 2K are arranged substantially below the intermediate transfer belt 1 along the moving direction of the intermediate transfer belt 1. Substantially below the four image forming units 2M, 2C, 2Y, and 2K, the optical scanner 20 is disposed.

At one end of the sheet feed cassette 12, the sheet feed mechanism 13 is disposed. The sheet feed mechanism 13 feeds recording media sheets P stored in the sheet feed cassette 12. The pair of registration rollers 14 is disposed substantially above the sheet feed mechanism 13. The secondary transfer roller 15 serves as a secondary transfer mechanism and is disposed substantially above the pair of registration rollers 14. The place where the secondary transfer roller 15 meets and presses against the intermediate transfer belt 1 is a secondary transfer portion. Substantially above the secondary transfer portion, the fixing unit 16 is disposed.

The sheet discharge tray 17 serves as an upper surface of the image forming apparatus. The sheet feed roller 18 discharges the recording medium P after an image formed on the recording medium P is fixed by the fixing device 16.

The image forming units 2M, 2C, 2Y, and 2K all have the same configuration as all the others, differing only in the color of toner employed. Thus, a description is provided of the image forming unit 2M as an representative example. To simplify the description, the reference characters M, C, Y, and K indicating colors are omitted herein.

The image forming unit 2 includes a photoreceptor 3 serving as an image bearing member, a charging roller 4, a developing device 5, a cleaning device 6, and so forth. The photoreceptor 3 rotates in a clockwise direction by a driving device, not illustrated. The charging roller 4, the developing device 5, the cleaning device 6, and so forth are disposed around the photoreceptor 3.

The developing device 5 is a two-component developing device using a two-component developing agent consisting of a toner and a carrier. The developing device 5 carries the toner on a developing sleeve and provides the toner to the photoreceptor 3.

A transfer roller 7 serving as a primary transfer mechanism is disposed opposite the photoreceptor 3 through the intermediate transfer belt 1.

The intermediate transfer belt 1 is wound around and stretched between a plurality of support rollers including a support roller 8 and a support roller 9, and rotated in a counterclockwise direction indicated by an arrow. The support roller 8 is disposed opposite the secondary transfer roller 15. The support roller 9 is disposed across from the support roller 8 and contacts the intermediate transfer belt 1. In proximity to the support roller 9, a belt cleaning device 19 is disposed. The belt cleaning device 19 contacts the intermediate transfer belt 1 opposite the support roller 9.

The optical scanner 20 projects light against the image forming units 2M, 2C, 2Y, and 2K. The optical scanner 20 includes a polygon mirror 57, scan lenses 58a and 58b serving as scan lenses, a toroidal lens 59, and a group of mirrors 31, 32, and 33.

A description is now provided of a printing operation of the image forming apparatus according to the illustrative embodiment.

In the image forming unit 2M for magenta the surface of the photoreceptor 3 is uniformly charged to a predetermined electric potential by the charging roller 4. In the optical scanner 20, a laser diode (LD), not illustrated, is driven to project laser light against the polygon mirror 57 based on image data provided by a host machine such as a personal computer or the like. Subsequently, the light reflected by the polygon mirror 57 is directed to the photoreceptor 3 through a cylindrical lens and so forth, thereby forming an electrostatic latent image on the photoreceptor 3M. The electrostatic latent image is developed with toner by the developing device 5, forming a toner image, also known as a visible image of magenta.

Similar to magenta, the visible images of cyan, yellow, and black are formed with toner on the respective photoreceptors 3 in the image forming units 2C, 2Y, and 2K. The visible images are transferred on the intermediate transfer belt 1 on one another.

The recording medium supplied from the sheet feed cassette 12 is conveyed upward to the pair of the registration rollers 14, contacts the registration rollers 14, and stops temporarily. Subsequently, the recoding medium is sent to the secondary transfer position defined by the secondary roller 15 and the intermediate transfer belt 1 in an appropriate timing such that the recording medium is aligned with the visible image. The visible image is transferred onto the recording medium by the secondary transfer roller 15.

In a case of monochrome printing operation, a toner image (visible image) of black is formed on the surface of the photoreceptor 3 in the image forming unit 2K for color black. The toner image of black is transferred onto the recording medium.

After the toner image is transferred on the recording medium, the toner image is fixed by the fixing unit 16. Subsequently, the recording medium on which the toner image is fixed is discharged onto the sheet discharge tray 17 at the upper portion of the image forming apparatus. As the recording medium is discharged, the recording medium is turned upside down to sequentially collate the recording media sheets.

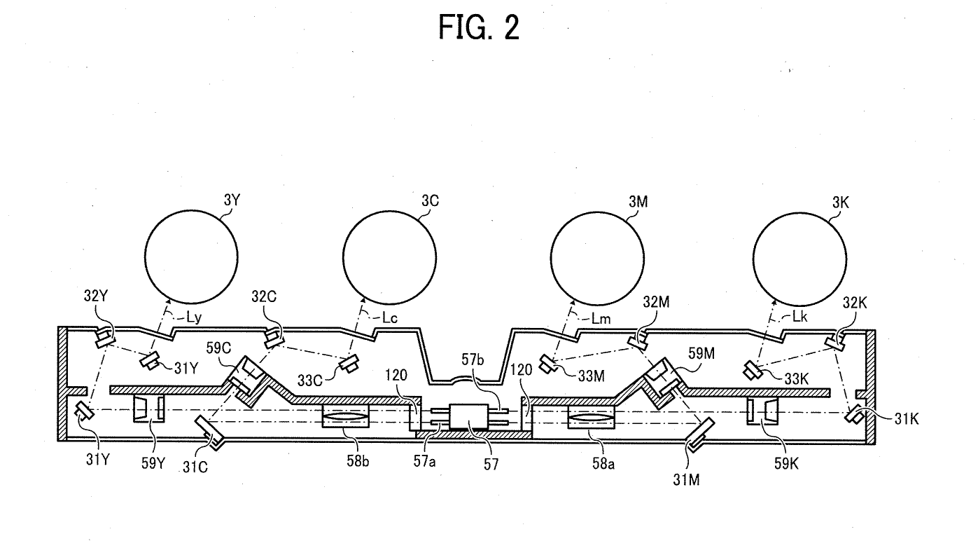

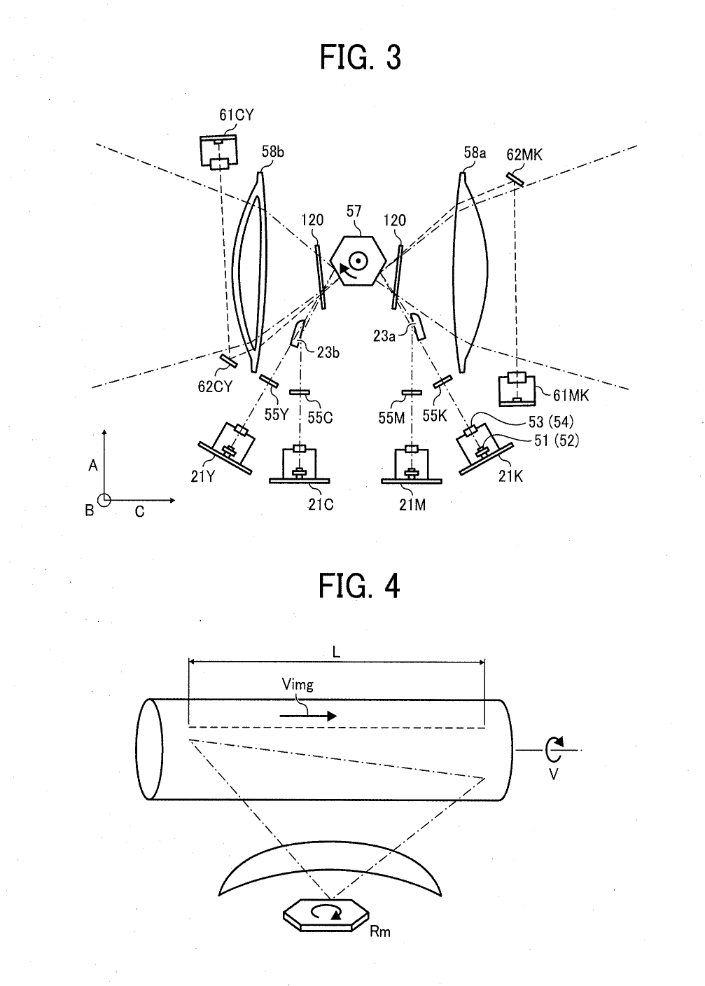

With reference to FIGS. 2 and 3, a description is provided of the optical scanner 20 according to the illustrative embodiment. FIG. 2 is a cross-sectional schematic diagram illustrating the optical scanner 20. FIG. 3 is a schematic diagram illustrating the optical scanner 20 as viewed from the bottom thereof.

In FIG. 2, as described above, the optical scanner 20 includes optical components such as the polygon scanner 57, various types of reflective mirrors and lenses. The polygon scanner 57 is disposed substantially at the center of the optical lens 20. The polygon scanner 57 includes an upper polygon mirror 57b and a lower polygon mirror 57a serving as a rotary deflector fixed to a rotary shaft of a polygon motor, not illustrated. The polygon scanner 57 is surrounded by a soundproof glass enclosure 120.

As illustrated in FIG. 2, the optical scanner 20 is an opposed scanning-type optical scanner. Substantially at the right side of the polygon scanner 57 as shown in FIG. 2, an optical system for magenta and an optical system for black are disposed. Similarly, substantially at the left side of the polygon scanner 57, an optical system for yellow and an optical system for cyan are disposed.

The optical system for yellow and the optical system for black are symmetrical with respect to the rotary axis of the polygon motor. Similarly, the optical system for cyan and the optical system for magenta are symmetrical with respect to the rotary axis of the polygon motor.

As illustrated in FIG. 3, the optical scanner 20 includes light source units 21K, 21M, 12C, and 21Y serving as light projectors that project light beams Lk, Lm, Lc, and Ly against the photoreceptors 3K, 3M, 3C, and 3Y, respectively. Each of the light source units 21 includes two semiconductor laser diodes 51 and 52 serving as light sources, and two collimator lenses 53 and 54 corresponding to the laser diode 51 and 52.

The optical scanner 20 includes imaging lenses (cylinder lenses) 55K, 55M, 55C, and 55Y, and reflective mirrors 23a and 23b serving as the optical components. The imaging lenses 55K, 55M, 55C, and 55Y, and the reflective mirrors 23a and 23b are disposed on light paths of the light beams from the light sources 21 to the polygon scanner 57.

The scan lenses 58a and 58b, first mirrors 31K, 31M, 31C, and 31Y, second mirrors 32K, 32M, 32C, and 32Y, third mirrors 33K, 33M, 33C, and 33Y, and toroidal lenses 59K, 59M, 59C, and 59Y are disposed on the optical paths from the polygon scanner 57 to illumination targets, the photoreceptors 3.

In FIG. 3, a beam detector 61MK is disposed substantially at the bottom right. The beam detector 61MK detects leading edges of the light beams Lm for magenta and Lk for black.

A beam detector 61CY for detecting the leading edges of the light beams LC for cyan and LY for yellow is in a symmetrical position with respect to the beam detector 61MK about the rotary axis of the polygon motor (at the upper left in FIG. 3).

The light beam projected form the light source unit 21K for black passes through an aperture, not illustrated and is shaped to a desired shape, thereby forming the light beam Lk. The light beam Lk that passed through the aperture strikes the imaging lens (cylindrical lens) 55K, thereby correcting an optical face tangle error.

The light beam Lk that passes through the imaging lens 55K is reflected by the reflective mirror 23a, passes through the soundproof glass enclosure 120, and strikes a side face of the upper polygon mirror 57b. As the light beam Lk strikes the side face of the upper polygon mirror 57b, the light beam is deflected in a main scanning direction by the upper polygon mirror 57b. Subsequently, the light beam Lk deflected by the upper polygon mirror 57b passes again through the soundproof glass enclosure 120 and is focused by the scan lens 58a (f-theta lens).

The light beam Lk for black focused by the scan lens 58a is reflected by a reflection mirror 62MK before scanning the photoreceptor 3K. The light beam Lk strikes the beam detector 61MK and is detected by the beam detector 61MK. When the beam detector 61MK detects the light beam Lk, a synchronization signal is output. In accordance with the synchronization signal, a timing with which a light source signal converted based on the image data is output is adjusted.

The light beam Lk projected in accordance with the image data passes through the imaging lens 55K and so forth, is deflected by the upper polygon mirror 57b, and strikes the scan lens 58a. Subsequently, the light beam Lk incident upon the scan lens 58a passes through the toroidal lens 59K, as illustrated in FIG. 2. After passing through the toroidal lens 59K, the light beam Lk illuminates the photoreceptor 3K through the first mirror 31K, the second mirror 32K, and the third mirror 33K.

Similar to the light beam Lk for black, the light beam Lm for magenta projected from the light source unit 21M passes through the imaging lens 55M and so forth, is reflected by the reflective mirror 23a, and deflected by the lower polygon mirror 57a.

The light beam Lm deflected by the lower polygon mirror 57a strikes the scan lens 58a and then strikes the beam detector 61MK before scanning the photoreceptor 3M. The synchronization signal is output. In accordance with the synchronization signal, the light beam Lm is projected based on the image data. The light beam Lm illuminates the photoreceptor 3M through the imaging lens 55M, the lower polygon mirror 57a, the scan lens 58a, the first mirror 31M, the toroidal lens 59M, the second mirror 32M, and the third mirror 33M.

The light beam Lc for cyan projected from the light source unit 21C passes through the imaging lens 55C and so forth, is reflected by the reflective mirror 23b, and deflected by the lower polygon mirror 57a.

The light beam Lc deflected by the lower polygon mirror 57a strikes the scan lens 58b and then strikes the beam detector 61CY before scanning the photoreceptor 3C. The synchronization signal is output. In accordance with the synchronization signal, the light beam Lc is projected based on the image data. The light beam Lc illuminates the photoreceptor 3C through the imaging lens 55C, the lower polygon mirror 57a, the scan lens 58b, the first mirror 31C, the toroidal lens 59C, the second mirror 32C, and the third mirror 33C.

The light beam Ly for yellow projected from the light source unit 21Y passes through the imaging lens 55Y and so forth, is reflected by the reflective mirror 23b, and deflected by the upper polygon mirror 57b.

The light beam Ly deflected by the upper polygon mirror 57b passes through the scan lens 58b and then reflected by the reflective mirror 62CY before scanning the photoreceptor 3Y. The reflected light beam Ly strikes the beam detector 61CY, and the synchronization signal is output. In accordance with the synchronization signal, the light beam Ly is projected based on the image data. The light beam Ly illuminates the photoreceptor 3Y through the imaging lens 55Y, the upper polygon mirror 57b, the scan lens 58b, the toroidal lens 59Y, the first mirror 31Y, the second mirror 32Y, and the third mirror 33Y.

According to the illustrative embodiment described above, the image forming apparatus includes a plurality of image forming modes with different process linear velocities V. TABLE 1 shows the linear velocities “V” [mm/sec] of the photoreceptor, the number of light beams “N” in each of the image forming modes, and so forth.

TABLE 1

| | IMAGE FORMING MODE | | | |
|---|---|---|---|---|
| | A | A′ | B | C |
| LINEAR VELOCITY: V | 100 | 100 | 250 | 300 |
| [mm/sec] | | | | |
| NUMBER OF LIGHT | 1 | 2 | 2 | 2 |
| BEAMS: N | | | | |
| NUMBER OF | 6 | 6 | 6 | 6 |
| REFLECTIVE | | | | |
| FACES: M | | | | |
| PIXEL DENSITY: ρ | 600 | 600 | 600 | 600 |
| [dpi] | | | | |
| Number of revolutions | 23622 | 11811 | 29528 | 35433 |
| Rm [rpm] | | | | |
| RATIO: | 4.23 | 8.47 | 8.47 | 8.47 |
| K□V/Rm × 1000 | | | | |

In TABLE 1, “Rm” represents the number of revolutions of the polygon mirrors 57a and 57b serving as the rotary deflector. The number of revolutions Rm is configured to satisfy EQUATION 1 described above. As shown in TABLE 1, in the image forming mode A in which the linear velocity V of the photoreceptor is the smallest and the number of the light beams N is 1, the ratio of the linear velocity V to the number of revolutions Rm of the polygon mirrors 57a and 57b differs from those of other image forming modes A′, B, and C.

The number of revolutions Rm of the polygon mirrors 57a and 57b is proportional to the scan speed Vimg of the light beam scanned on the surface of the photoreceptor 3 (Rm □Vimg). Hence, the ratio K (V/Rm)=(V/Vimg), that is the ratio K of the linear velocity V of the photoreceptor to the scan speed Vimg of the light beam in the image forming mode A is different from the ratio K in other image forming modes.

Referring now to FIG. 4, there is provided an explanatory diagram for explaining an inclination of the scan line caused by a change in the ratio K of the process linear velocity V to the scan speed Vimg. In FIG. 4, L represents a width of the scan line scanned on the surface of the photoreceptor 3.

The scan time t on the surface of the photoreceptor 3 is t=L/Vimg. Since the photoreceptor 3 is rotated at the linear velocity V, the scan line scanned on the surface of the photoreceptor 3 is inclined by an amount α (=V×(L/Vimg)).

Normally, a relevant lens may be adjusted so that the scan line is not inclined in a default image forming mode, for example, the image forming mode C in TABLE 1. Therefore, as may be seen in TABLE 1, in the image forming modes A′ and B having the same ratio K as that of the image forming mode C, the amount of inclination α of the scan line scanned on the surface of the photoreceptor 3 does not change.

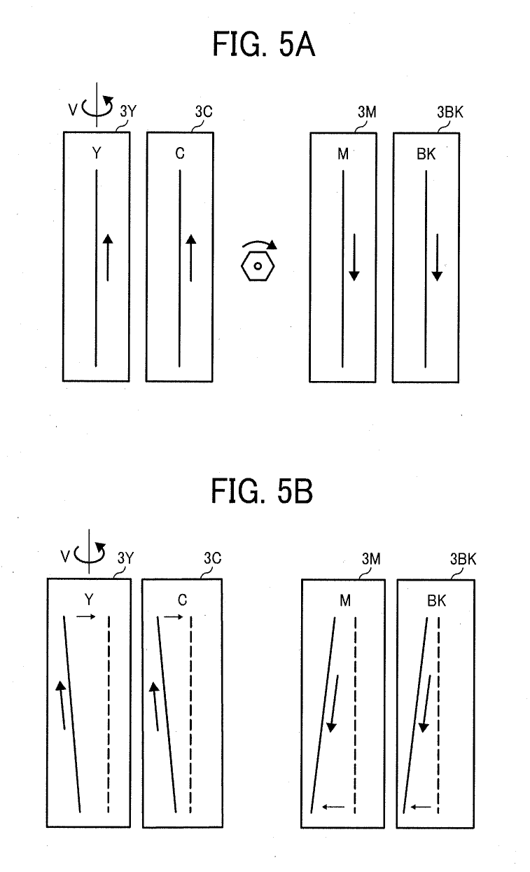

By contrast, in the image forming mode A in which the ratio K is different from the default image forming mode C, the amount of inclination α of the scan line changes, causing the scan line to incline as indicated in a solid line in FIG. 5B.

With reference to FIGS. 5A and 5B, which are explanatory diagrams illustrating the inclination of the scan line on the photoreceptor 3, a description is provided of the inclination of the scan line on the photoreceptor caused by the change in the ratio K of the scan speed Vimg to the process linear velocity V when the polygon mirrors 57a and 57b are disposed substantially at the center of the optical scanner 20 and the optical components such as the scan lens (f-theta lens) 58 and the toroidal lens 59 are disposed in a point-symmetrical position with respect to the rotary axis of the polygon mirrors 57a and 57b.

As illustrated in FIG. 5A, the light beam directed to each of the photoreceptors 3 disposed at the left side of the polygon mirrors 57a and 57b scans the photoreceptors 3 from the lower portion to the upper portion. By contrast, the light beam directed on each of the photoreceptors 3 disposed at the right side of the polygon mirrors 57a and 57b scans the photoreceptors 3 from the upper portion to the lower portion.

In such an optical scanner 20, the direction of projection of light that scans the photoreceptors 3 disposed at the left side of the polygon mirrors 57a and 57b is different from the direction of projection of light that scans the photoreceptors 3 disposed at the right side of the polygon mirrors 57a and 57b. As a result, as illustrated in FIG. 5B, a change in the ratio K of the linear velocity V to the scan speed Vimg may result in a difference in the inclination of the scan line between the left-side photoreceptors and the right-side photoreceptors.

Consequently, when toners of different colors are superimposed on one another to form a color image, a color drift may occur in the color image.

In view of the above, according to the illustrative embodiment, the optical scanner 20 includes an inclination adjustment unit that adjusts an inclination of a scan line on the photoreceptor 3 in accordance with the ratio K (K=V/Vimg) of the process linear velocity V to the scan speed Vimg at which the light beam projected from the light source scans the photoreceptor.

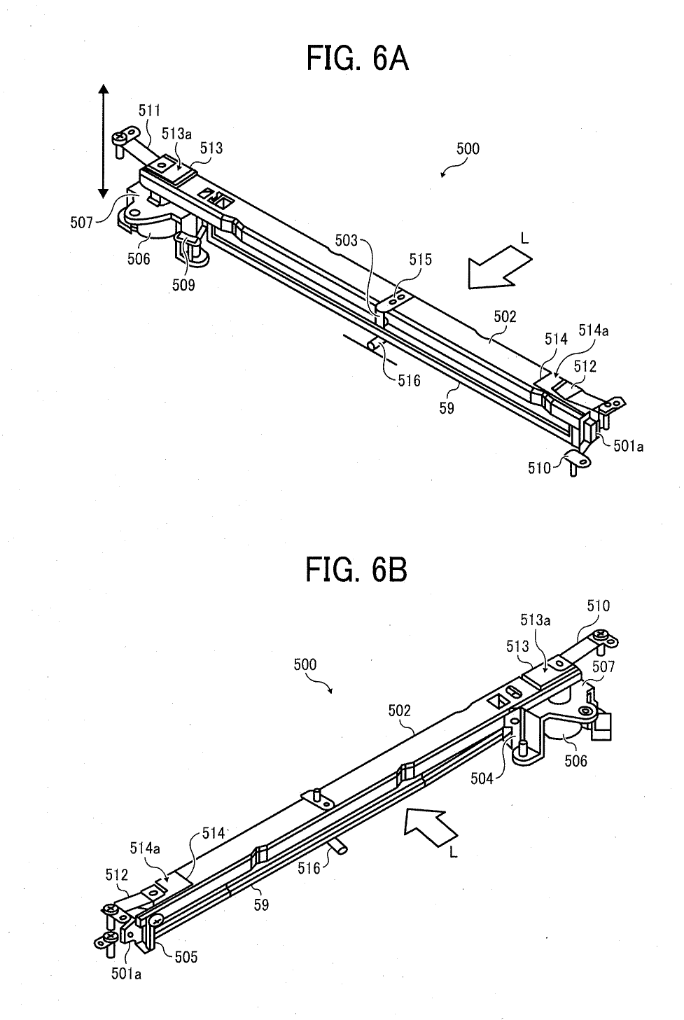

With reference to FIGS. 6A and 6B, a description is now provided of a scan lens unit 500 serving as the inclination adjustment unit. FIGS. 6A and 6B are perspective schematic views of the scan lens unit 500.

The scan lens unit 500 includes a bracket 502, a leaf spring 503, leaf springs 504 and 505, a stepping motor 506, a motor holder 507, a screw receiving portion, a housing fixing member 509, leaf springs 510, 511, and 512, smooth-surface members 513 and 514, and an adjustment screw 515.

The bracket 502 supports the toroidal lens 59 serving as the scan lens. The leaf spring 503 adjusts the bending of the bracket 502. The leaf springs 504 and 505 fix the toroidal lens 59 and the bracket 502. The stepping motor 506 adjusts automatically the inclination of the scan line. The leaf springs 510, 511, and 512 support the scan lens unit 500. The smooth-surface members 513 and 514 serve as a friction coefficient reduction mechanism. The adjustment screw 515 adjusts the bending of the bracket 502.

The inclination of the scan line is adjusted by controlling a rotation angle of the stepping motor 506 in accordance with a necessary amount of adjustment of inclination. When the rotation angle of the stepping motor 506 is controlled, an up-and-down screw mounted on the rotary shaft of the stepping motor 506 moves up and down, causing an end portion of the scan lens unit 500 at the side of the stepping motor 506 to move in the direction of the double-headed arrow shown in FIG. 6A.

More specifically, when the up-and-down screw moves up, the end portion of the scan lens unit 500 at the side of the stepping motor 506 also moves up against an urging force of the leaf spring 511. The scan lens unit 500 swings about a support member 516, thereby changing its orientation.

By contrast, when the up-and-down screw moves down, the end portion of the scan lens unit 500 at the side of the motor moves down due to the urging force of the leaf spring 511. Accordingly, the scan lens unit 500 swings about the support member 516, thereby changing its orientation.

Such a change in the orientation of the scan lens unit 500 results in a change in an incident position of the light beam L relative to the incident face of the toroidal lens 59.

The toroidal lens 59 has a characteristic such that when the incident position of the light beam L relative to the incident face of the toroidal lens 59 shifts in a direction perpendicular to a longitudinal direction of the toroidal lens 59 (vertical direction) and a direction of the light path, an angle of the light beam emerging from an emerging face of the toroidal lens 59, that is, the emerging angle of the light beam L relative to the vertical direction, changes.

With such a characteristic, when the orientation of the scan lens unit 500 is changed by the movement of the up-and-down screw, the emerging angle of the light beam L emerging from the emerging face of the toroidal lens 59 is changed, thereby changing the inclination of the scan line on the photoreceptor.

Each of the toroidal lenses 59Y, 59M, 59C, and 59K is provided with the scan lens unit 500 described above.

According to the illustrative embodiment, the inclination of the scan line is adjusted by changing the orientation of the toroidal lens 59. Alternatively, the inclination of the scan line may be adjusted by changing the orientation of the third mirror 33.

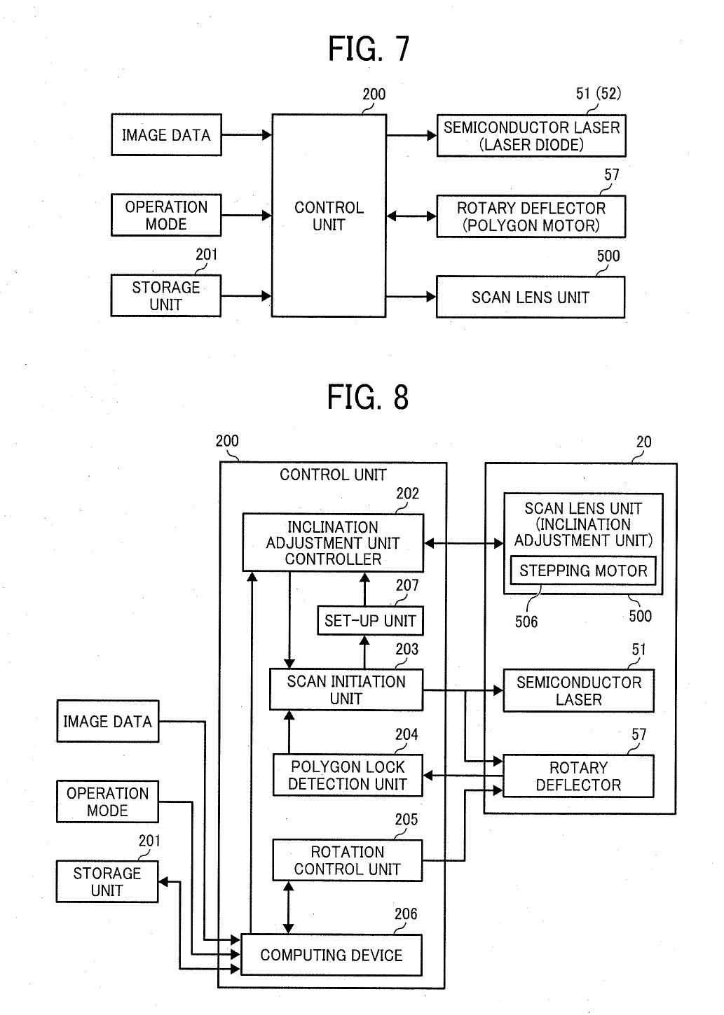

With reference to FIGS. 7 and 8, a description is provided of control of the optical scanner 20 according to the illustrative embodiment. FIG. 7 is a block diagram illustrating a portion of an electric circuit of the optical scanner 20. FIG. 8 is a block diagram illustrating a control unit 200 according to the illustrative embodiment.

In FIG. 7, the control unit 200 generally controls the image forming apparatus including the optical scanner 20. Various devices and sensors are connected to the control unit 200. In FIG. 7, devices and sensors that are associated with characteristic features of the illustrative embodiment are shown.

The control unit 200 includes a Central Processing Unit (CPU), a Read Only Memory (ROM), a Random Access Memory (RAM), and so forth. Various programs are executed on such hardware components to implement functions of various devices.

As illustrated in FIG. 8, the control unit 200 includes an inclination adjustment unit controller 202, a scan initiation unit 203, a polygon lock detection unit 204, a rotation control unit 205, a computing device 206, and a set-up unit 207.

The control unit 200 controls semiconductor lasers 51 and 52, and the polygon motor based on the image forming modes. The rotation control unit 205 of the control unit 200 controls the number of revolutions Rm of the polygon mirrors 57a and 57b serving as the rotary deflector.

The inclination adjustment unit controller 202 of the control unit 200 controls the scan lens unit 500 serving as the inclination adjustment unit in accordance with the ratio K of the scan speed Vimg to the linear velocity V of the photoreceptor 3, thereby adjusting the inclination of the scan line on the photoreceptor 3.

A storage unit 201 correlates and stores the ratio K from a previous image forming operation, the number of revolutions Rm of the polygon mirrors 57a and 57b, the ratio K, and the linear velocity V for each of the image forming modes.

The computing device 206 of the control unit 200 calculates an amount of inclination adjustment of the scan line based on the ratio K from the previous image forming operation stored in the storage unit 201 and the ratio K of the present image forming operation.

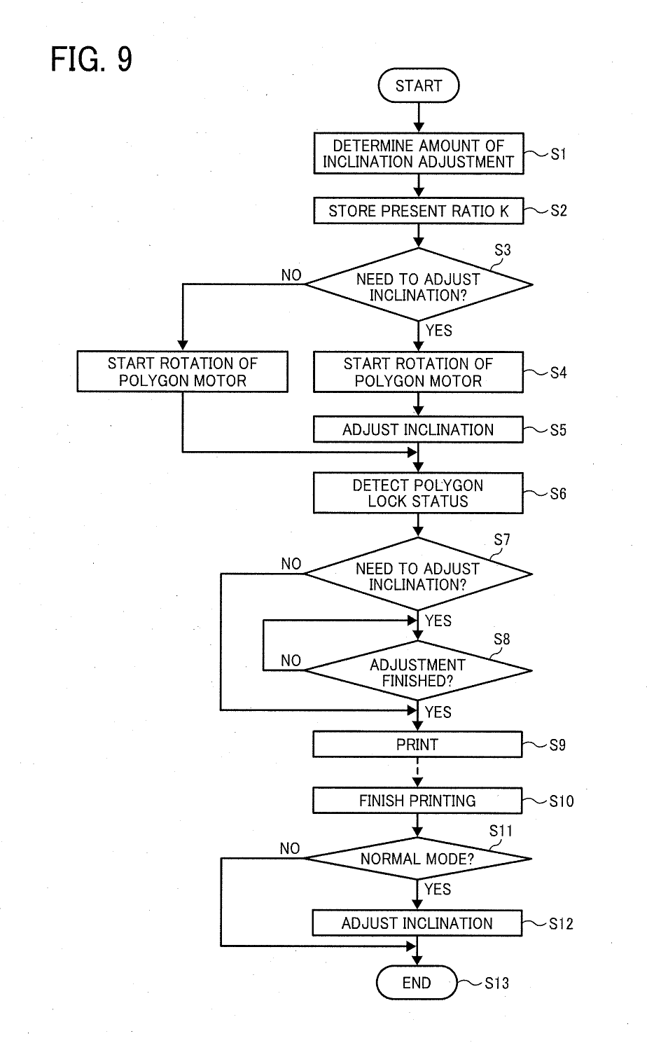

With reference to FIG. 9, a description is now provided of an exemplary procedure of the inclination adjustment when the ratio K changes.

At S1, the control unit 200 reads out a previous ratio K stored in the storage unit 201 and a present ratio K corresponding to the present image forming mode. Based on the previous ratio K and the present ratio K, the control unit 200 calculates a necessary amount of the inclination adjustment, that is, the rotation angle of the stepping motor 506 (S1).

According to the illustrative embodiment, the ratio K for each of the image forming modes is stored in the storage unit 201. The control unit 200 reads out the ratio K of the present image forming mode from the storage unit 201. Alternatively, however, the ratio K may be calculated based on the linear velocity V and the number of revolutions Rm of the polygon mirrors 57a and 57b corresponding to the present image forming mode.

Still alternatively, the necessary amount of inclination adjustment may be stored in the storage unit 201 for each pattern of change in the ratio K in advance. Subsequently, it is determined which change pattern stored in the storage unit coincides with the change pattern of the change from the previous ratio K to the present ratio K. Then, the necessary amount of inclination adjustment corresponding to the obtained change pattern is read out from the storage unit 201.

Next, at S2, the ratio K of the present image forming operation is stored in the storage unit 201 (S2). If the present ratio K is different from the previous ratio K, it is determined that the inclination needs to be adjusted (YES at S3) and the polygon motor starts to be driven at S4. Immediately after the polygon motor starts to be driven, inclination adjustment is started at S5.

Subsequently, the polygon lock detection unit 204 of the control unit 200 detects whether or not a polygon motor lock signal is output. The polygon motor lock signal is output when the polygon motor is rotated at a constant rotation speed.

At S7, whether or not it was determined at S3 that the inclination adjustment needed to be performed is verified. If, at S3, it was determined that the inclination adjustment did not need to be performed (NO at S7), printing is started, that is, the light beam starts to scan at S9 after the polygon motor lock signal is detected.

By contrast, if it was determined at S3 that the inclination adjustment needed to be performed and thus inclination adjustment was performed (YES at S7), the control unit 200 determines whether or not the inclination adjustment is finished. In particular, whether or not the stepping motor 506 of the scan lens unit 500 finished receiving a pulse signal, that is, a drive signal, is verified. When the stepping motor 506 finishes receiving the pulse signal, it is determined that the inclination adjustment is finished.

Alternatively, completion of the inclination adjustment may be detected as follows. When the inclination adjustment is initiated, the control unit 200 starts to measure time. If the measured time corresponds to a time necessary for adjusting the inclination when the ratio K changes from the greatest ratio K (Max) to the smallest ratio K (Min) among a plurality the ratios K that the control unit 200 changes, it is determined that the inclination adjustment is completed. Since the amount of inclination adjustment (the rotation angle of the stepping motor 506) is the greatest when the ratio K changes from the greatest ratio (Max) to the smallest ratio (Min) K, the time required for adjusting the inclination takes the longest. Therefore, after the time necessary for adjusting the inclination as the ratio K changes from the greatest ratio K to the smallest ratio K elapses, the inclination adjustment is most likely finished.

Subsequently, when the control unit 200 determines that the inclination adjustment is completed at S8 (YES at S8), printing is initiated, that is, scanning of the light beam is started at S9.

After completion of the printing at S10, whether or not the operation setting of the image forming apparatus is a “normal mode” is determined at S11. According to the illustrative embodiment, the operation mode of the image forming apparatus is switched between the normal mode and a special mode at a control portion, such as a control panel of the image forming apparatus by a user or a service person.

It is to be noted that the normal mode is set when the image forming apparatus is frequently used in the default image forming mode, whereas the special mode is set when the image forming apparatus is frequently used under the image forming mode in which the ratio K is different from the ratio K of the default image forming mode. Based on the use of the image forming apparatus, either the normal mode or the special mode may be set.

When the user selects the normal mode at S11 (YES at S11), at S12 the inclination of the scan line is adjusted to prevent inclination of the scan line at the ratio K corresponding to the default image forming mode when the photoreceptor is not in operation, that is, the photoreceptor is stopped. By contrast, when the user selects the special mode (NO at S11), processing is finished without the inclination adjustment.

In a case in which the inclination adjustment is performed to prevent inclination of the scan line in the normal mode at the ratio K corresponding to the default image forming mode, the ratio K stored in the storage unit 201 at S2 is replaced with the ratio K corresponding to the default image forming mode.

As illustrated in FIG. 9, when the correction, that is, the inclination adjustment, is performed, whether or not the inclination adjustment is completed is determined. After completion of adjustment and the polygon lock status are detected, printing is initiated. With this configuration, printing does not start during the inclination adjustment, thereby preventing the scan line from getting inclined undesirably.

According to the illustrative embodiment, the polygon motor is driven before inclination adjustment is initiated, thereby preventing the polygon mirrors (rotary deflector) from entering the polygon lock status, for example, rotating at a constant speed after completion of the inclination adjustment. With this configuration, immediately after adjusting the inclination, printing can be started, thereby reducing the downtime before the start of printing.

As illustrated in FIG. 9, when the normal mode is set, after printing the inclination adjustment is performed to prevent the scan line from getting inclined at the ratio K in the default image forming mode. Accordingly, when printing in the default image forming mode at the subsequent print operation, the inclination adjustment is not performed before the printing operation starts.

With this configuration, if a user who frequently selects printing in the default image forming mode sets the normal mode, the number of inclination adjustments is reduced in the next printing operation, thereby reducing the frequency of the long downtime before the start of printing.

By contrast, when the special mode is set, no inclination adjustment is performed after printing and the image forming operation is finished. As a result, in a case in which the subsequent printing is performed under the same image forming mode as the previous printing operation, the inclination adjustment is not performed before printing starts.

With this configuration, if a user who frequently requests printing in the special image forming mode in which the ratio K is different from the ratio K of the default image forming mode sets the special mode, the number of inclination adjustment before the start of printing is reduced, thereby reducing the frequency of the long downtime before the start of printing.

A description is now given of automatic adjustment of inclination using an optical sensor unit.

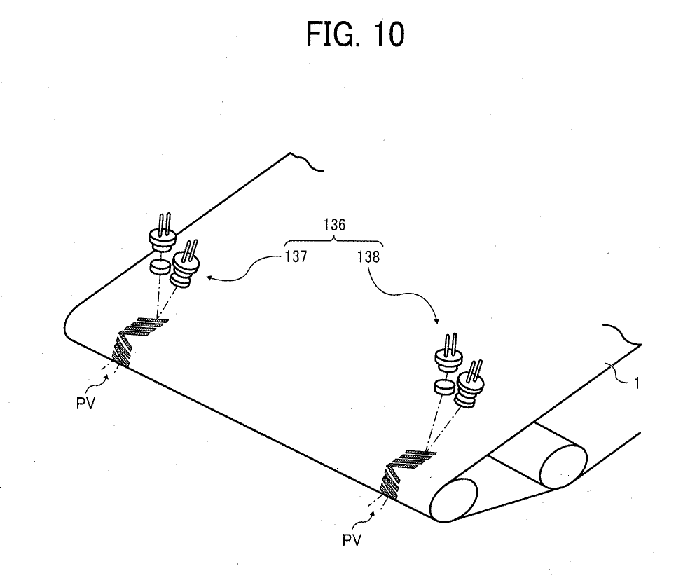

Referring now to FIG. 10, there is provided a perspective schematic view of a portion of the intermediate transfer belt and an optical sensor unit 136. According to the illustrative embodiment, the image forming apparatus includes the optical sensor unit 136 as illustrated in FIG. 10, serving as a toner mark detector that includes two reflective optical sensors, that is, a first optical sensor 137 and a second optical sensor 138.

The optical sensor unit 136 automatically adjusts inclination of the scan line and so forth each time a certain number of sheets is output when the internal temperature of the image forming apparatus and its ambient environment change. The first optical sensor 137 and the second optical sensor 138 are spaced a certain distance therebetween in a width direction of the intermediate transfer belt 1.

The inclination adjustment of the scan line is performed by forming a pattern image PV consisting of a plurality of toner marks used for adjustment substantially at both end portions of the intermediate transfer belt 1 in the width direction thereof. The positions of the toner marks are detected based on the output of the first optical sensor 137 and the second optical sensor 138. Accordingly, when the color black, for example, is used as a reference standard color, an amount of color drift of other colors relative to the color black can be calculated. Subsequently, the amount of inclination of the scan line of colors other than the color black is obtained and output to the control unit 200. Based on the calculation result, the control unit 200 controls the rotation angles of the stepping motor 506 for each of the scan lens units 500 of other colors yellow, cyan, and magenta, and changes the orientation of the toroidal lenses 59, thereby adjusting inclination of the scan lines scanned on the photoreceptors.

The linear velocity V of the photoreceptor, the number N of light beams, and the number of revolutions Rm of the polygon mirror 57a and 57b when forming the pattern images PV for adjustment are configured as follows.

The linear velocity V of the photoreceptor is set to the slowest linear velocity among the image forming modes in which the number of light beams N is 1. The number of revolutions Rm of the polygon mirrors 57a and 57b is set to the number of revolution corresponding to the image forming mode in which the number N of light beams is 1 and the linear velocity V is the smallest. The number N of the light beams is set to the greatest number of light beams that the optical scanning unit can project.

In other words, the pattern image PV for adjustment is formed when the number of light beams is set to 2, and the linear velocity V of the photoreceptor and the number of revolutions Rm of the polygon mirrors 57a and 57b are set to the linear velocity and the number of revolutions of the image forming mode A of TABLE 1, respectively.

Setting the linear velocity V of the photoreceptor relatively slow can reduce the speed of each of the toner marks passing the optical sensors 137 and 138. The position of each of the toner marks is detected based on the change in the output of the optical sensors 137 and 138. By reducing the speed of the toner marks passing the optical sensors 137 and 138, the positions of the beginning and an end of change in the output of the optical sensors can be detected with precision.

When the number of revolutions of the polygon mirrors corresponds to the number of revolutions of the image forming mode in which the number of light beams is 1 and the linear velocity of the photoreceptor is the smallest, the pixel density in the sub-scanning direction can be increased by increasing the number of light beams.

For example, the number of revolutions Rm in the image forming mode A in TABLE 1 corresponds to the number of revolutions when the number of light beams is 1 and the pixel density ρ in the sub-scanning direction is 600 [dpi].

Increasing the number of light beams to 2 at the same number of revolutions Rm increases the pixel density in the sub-scanning direction 1200 [dpi]. As a result, the resolution of the latent image of the pattern image PV for adjustment is enhanced, thereby increasing an accuracy of detection of the position of the pattern images PV. With this configuration, error in the inclination adjustment based on the ratio K after the inclination adjustment based on the pattern images PV for adjustment is reduced.

It is to be noted that, prior to forming the pattern images PV for adjustment, the ratio K is calculated based on the preset linear velocity V of the photoreceptor and the number of revolutions Rm of the polygon mirrors 57a and 57b. Based on the calculated ratio K, the inclination of the scan line is adjusted. Alternatively, the pattern images PV may be formed such that the linear velocity V of the photoreceptor is set to the slowest linear velocity among the image forming modes, and the number of revolutions Rm of the polygon mirrors is set to the value obtained by EQUATION 1 (Rm=(60×ρ×V)/(25.4×M×N)), where the number N of the light beam is 1 (N=1), V is the linear velocity of the photoreceptor when the number of light beams is 1, and the number of light beams is the greatest.

An optical scanner according to an illustrative embodiment includes a light source that projects a light beam, polygon mirrors together serving as a rotary deflector that deflects and scans the light beam projected from the light source in the main scanning direction relative to the surface of a photoreceptor serving as a latent image baring member, and a scan lens unit serving as an inclination adjustment mechanism that adjusts an inclination of a scan line on the photoreceptor relative to a reference scan line.

The optical scanner includes a control unit. The control unit includes a rotation control mechanism. To accommodate a change in a linear velocity of the photoreceptor, the rotation control mechanism changes a number of revolutions of the rotary deflector so as to change a ratio of a scan speed of the light beam scanned on the photoreceptor to a linear velocity of the photoreceptor. Based on the ratio, an inclination adjustment mechanism controller controls the scan lens unit in order to prevent the scan line from getting inclined relative to the reference scan line.

The control unit includes a scan initiation mechanism that adjusts a timing of the start of scanning. When the inclination adjustment is finished and the polygon mirrors rotate at a constant speed at which a latent image is written on the photoreceptor surface, that is, the polygon mirrors enter the polygon lock status, the light beam starts to scan the surface of the photoreceptor. Such adjustment prevents the light beam from scanning the photoreceptor before the inclination adjustment is finished. Inclination of the scan line is prevented.

According to the illustrative embodiment described above, the polygon mirrors start to be driven before the inclination adjustment is initiated. With this configuration, the polygon mirrors are prevented from entering the polygon lock status, that is, rotating at a constant speed, after the inclination adjustment. Accordingly, printing can be started immediately after the inclination adjustment, and thus the downtime before the start of printing can be reduced.

According to the illustrative embodiment described above, a storage unit stores the ratio in the previous scanning of the light beam on the photoreceptor. Before the polygon mirrors start to be driven, a computing mechanism calculates an amount of adjustment of the scan line based on the previous ratio stored in the storage unit and the ratio of the present scanning.

The scan lens unit includes a stepping motor. By controlling a rotation angle of the stepping motor based on the amount of the inclination adjustment, an orientation of a toroidal lens serving as an optical element disposed on a light path of the light beam from the polygon mirror to the surface of the photoreceptor can be adjusted.

The control unit includes a polygon lock detection mechanism that detects rotation of the polygon mirrors at a constant speed at which the latent image is written on the surface of the photoreceptor. After a pulse signal serving as a drive signal provided to the stepping motor is input, the control unit 200 allows scanning of the light beam. With this configuration, the light beam is prevented from scanning the photoreceptor before completion of the inclination adjustment, thus preventing inclination of the scan line.

The image forming apparatus according to the illustrative embodiment described above includes a plurality of image forming modes having different ratios of linear velocity to scan speed. Completion of adjustment may be determined by determining whether or not an elapsed time (T1) after the scan lens unit starts adjusting the inclination has reached a certain time (T2) required for the inclination adjustment when the image forming mode changes from the image forming mode with the greatest ratio to the image forming mode with the smallest ratio.

The time T2 required for adjustment when the greatest ratio (Max) changes to the smallest ratio (Min) is the longest adjustment time. Thus, if the elapsed time T1 after the scan lens unit 500 starts the inclination adjustment reaches the time T2, this indicates that the inclination adjustment of the scan line is most likely completed. Hence, the light beam is prevented from scanning the photoreceptor before completion of the inclination adjustment by starting the printing operation after the time T1 reaches the time T2. Inclination of the scan line is prevented.

After the light beam finishes scanning the surface of the photoreceptor, the scan lens unit adjusts inclination based on the ratio of a default image forming mode associated with a normal printing condition. The normal printing is performed in the default image forming mode. This means that the inclination adjustment does not have to be always performed before printing. Accordingly, if the subsequent printing operation is performed under the default image forming mode, it is not necessary to perform the inclination adjustment before printing starts.

As a result, the number of adjustments of inclination before printing starts is reduced, and thus the downtime before printing can be reduced.

Whether or not the inclination adjustment is performed after the light beam is scanned on the surface of the photoreceptor may be selectively set in a set-up mechanism of the control unit. If it is set that the inclination adjustment is not performed after the light beam is scanned on the surface of the photoreceptor and the ratio in the next printing is the same as the ratio K in the previous printing, there is no need to perform the inclination adjustment before printing.

With this configuration, if a user who frequently selects a special image forming mode in which the ratio is different from the ratio of the default image forming mode sets that no inclination adjustment is to be performed after the surface of the photoreceptor is scanned by the light beam, the number of adjustments of inclination before printing can be reduced, thereby reducing the downtime before printing.

The image forming apparatus according to the illustrative embodiment described above includes the above-described optical scanner, thereby preventing a defective image.

The image forming apparatus includes an optical sensor unit serving as a toner mark detector that detects a toner mark formed on the photoreceptor or the transfer member, for example, the intermediate transfer belt. The scan lens unit adjusts inclination of the scan line based on the position of the toner mark detected by the optical sensor unit. The linear velocity of the photoreceptor when forming the toner mark on the photoreceptor is set to the slowest linear velocity among a plurality of the image forming mode. Accordingly, the speed of the toner mark passing the position opposite the optical sensor unit is reduced, thereby enhancing detection of the position of the toner mark by the optical sensor unit. As a result, error in the inclination adjustment based on the ratio K is reduced.

According to the illustrative embodiment, the number of revolutions of the polygon mirrors when forming the toner mark on the photoreceptor is set to the number of revolution associated with the image forming mode with a single optical beam. The number of light beams is set to the maximum. With this configuration, the pixel density in the sub-scanning direction is increased when forming the toner mark, thereby enhancing the positional accuracy in the sub-scanning direction of the toner mark and enabling the inclination adjustment with precision.

The linear velocity of the photoreceptor as the toner mark is formed on the photoreceptor is set to the slowest linear velocity associated with the image forming mode with a single light beam. The number of revolutions of the polygon mirrors is set to the number of revolutions associated with the image forming mode with a single light beam in which the linear velocity of the photoreceptor is the smallest. The number of the light beams is set to the maximum.

With this configuration, the speed of the toner mark passing the position opposite the optical sensor unit is reduced, thereby enhancing detection of the position of the toner mark by the optical sensor unit. As a result, the error in the inclination adjustment based on the ratio K is reduced.

According to the illustrative embodiment described above, the present invention is employed in the image forming apparatus. The image forming apparatus includes, but is not limited to, an electrophotographic image forming apparatus, a copier, a printer, a facsimile machine, and a digital multi-functional system including at least two of these functions thereof.

Furthermore, it is to be understood that elements and/or features of different illustrative embodiments may be combined with each other and/or substituted for each other within the scope of this disclosure and appended claims. In addition, the number of constituent elements, locations, shapes and so forth of the constituent elements are not limited to any of the structure for performing the methodology illustrated in the drawings.

Still further, any one of the above-described and other exemplary features of the present invention may be embodied in the form of an apparatus, method, or system.

For example, any of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and configured to perform any one of the aforementioned methods when run on a computer device (a device including a processor). Thus, the storage medium or computer readable medium can be configured to store information and interact with a data processing facility or computer device to perform the method of any of the above-described embodiments.

The storage medium may be a built-in medium installed inside a computer device main body or a removable medium arranged so that it can be separated from the computer device main body. Examples of a built-in medium include, but are not limited to, rewriteable non-volatile memories, such as ROMs and flash memories, and hard disks. Examples of a removable medium include, but are not limited to, optical storage media such as CD-ROMs and DVDs; magneto-optical storage media, such as MOs; magnetism storage media including but not limited to floppy disks (trademark), cassette tapes, and removable hard disks; media with a built-in rewriteable non-volatile memory, such as memory cards; and media with a built-in ROM, such as ROM cassettes.

Example embodiments being thus described, it will be obvious that the same may be varied in many ways. Such exemplary variations are not to be regarded as a departure from the scope of the present invention, and all such modifications as would be obvious to one skilled in the art are intended to be included within the scope of the following claims.

What is claimed is:

1. An optical scanner, comprising:
a light projector to project a light beam;
a rotary deflector to deflect the light beam against a latent image bearing member to scan the latent image bearing member in a main scanning direction;
a rotation control unit to change a number of revolutions of the rotary deflector to change a ratio of a scan speed of the light beam scanning the surface of the latent image bearing member to a linear velocity of the latent image bearing member as the linear velocity of the latent image bearing member changes;
an inclination adjustment unit to adjust inclination of a scan line relative to a reference scan line on the latent image bearing member;
an inclination adjustment unit controller to adjust the inclination adjustment unit based on the ratio to prevent the scan line from being inclined relative to the reference scan line; and
a scan initiation unit to initiate scanning of the surface of the latent image bearing member by the light beam after adjustment of inclination by the inclination adjustment unit is completed and the rotary deflector starts rotating at a constant speed for writing the latent image on the surface of the latent image bearing member.

2. The optical scanner according to claim 1, wherein the rotary deflector starts to be driven before the inclination adjustment.

3. The optical scanner according to claim 2, further comprising:
a storage unit to store the ratio of the scan speed of the light beam to the linear velocity of the latent image bearing member in a previous scan of the surface of the latent image bearing member with the light beam; and
a computing device to calculate, before driving the rotary deflector, an amount of inclination adjustment of the scan line based on a comparison of the previous ratio stored in the storage unit and the present ratio of the scan speed of the light beam scanned on the latent image bearing member in the present scan.

4. The optical scanner according to claim 1, wherein the inclination adjustment unit includes a stepping motor and a polygon lock detection unit, a rotation angle of the stepping motor is controlled based on the amount of inclination adjustment to change an orientation of an optical element disposed in a light path of the light beam from the rotary deflector to the surface of the latent image bearing member relative to the light beam, and the polygon lock detection unit detects whether or not the rotary deflector rotates at the constant speed for writing the latent image on the surface of the latent image bearing member, and
wherein the inclination adjustment unit controller initiates scanning of the surface of the latent image bearing member with the light beam when the polygon lock detection unit detects rotation of the rotary deflector at the constant speed for writing the latent image on the latent image bearing member, and at completion of supply of a drive signal to the stepping motor.

5. The optical scanner according to claim 1, further comprising:
a polygon lock detection unit to detect whether or not the rotary deflector rotates at the constant speed at which the rotary deflector rotates to write the latent image on the surface of the latent image bearing member; and
a plurality of operation modes having different ratios of the scan speed of the light beam to the linear velocity of the latent image bearing member,
wherein the inclination adjustment unit controller initiates scanning of the light beam on the surface of the latent image bearing member when the polygon lock detection unit detects rotation of the rotary deflector at the constant speed for writing the latent image on the latent image bearing member and when an elapsed time after the start of the inclination adjustment reaches a time necessary for the inclination adjustment when the operation mode with the greatest ratio changes to the operation mode with the smallest ratio.

6. The optical scanner according to claim 1, further comprising a plurality of operation modes including a default operation mode for a normal printing and having different ratios of the scan speed of the light beam to the linear velocity of the latent image bearing member,
wherein the inclination adjustment unit adjusts inclination based on the ratio of the default operation mode after the light beam scans the surface of the latent image bearing member.

7. The optical scanner according to claim 6, further comprising a set-up unit that determines whether or not the inclination adjustment is to be performed after the light beam scans the surface of the latent image bearing member.

8. An image forming apparatus, comprising:
a latent image bearing member to bear a latent image on a surface thereof;
an optical writing unit to write the latent image on the surface of the latent image bearing member;
a developing unit to develop the latent image on the latent image bearing member with toner to form a visible image; and
a transfer device to transfer the visible image from the image bearing member to a transfer member,
wherein the optical writing unit includes the optical scanner of claim 1.

9. The image forming apparatus according to claim 8, further comprising:
a toner mark detector to detect a toner mark formed on either the latent image bearing member or the transfer member; and
a plurality of image forming modes having different linear velocities of the latent image bearing member,
wherein the inclination adjustment unit of the optical scanner adjusts the inclination of the scan line based on the position of the toner mark detected by the toner mark detector, and the linear velocity of the latent image bearing member is set to the slowest linear velocity among the plurality of the image forming modes when forming the toner mark on the latent image bearing member.

10. The image forming apparatus according to claim 8, further comprising:
a toner mark detector to detect a toner mark formed on either the latent image bearing member or the transfer member; and
a plurality of image forming modes having either different linear velocities of the latent image bearing member or different number of light beams;
wherein the inclination adjustment unit adjusts the inclination of the scan line based on the position of the toner mark detected by the toner mark detector, the number of revolutions of the rotary deflector is set to the value in the image forming modes having a single light beam when forming the toner mark on the latent image bearing member, and the number of light beams is set to the maximum number of light beams with which the apparatus can operate when forming the toner mark on the latent image bearing member.

11. The image forming apparatus according to claim 10, wherein when forming the toner mark on the latent image bearing member, the linear velocity of the latent image bearing member is set to the slowest linear velocity among the image forming modes with a single light beam, and the number of revolutions is set to the value in the image forming mode with the slowest linear velocity of the latent image bearing member.

12. A method of scanning a light beam, comprising:
projecting a light beam;
deflecting the light beam against a latent image bearing member to scan the latent image bearing member in a main scanning direction;
changing a number of revolutions of the rotary deflector to change a ratio of a scan speed of the light beam scanning the surface of the latent image bearing member to a linear velocity of the latent image bearing member as the linear velocity of the latent image bearing member changes;
adjusting inclination of a scan line relative to a reference scan line on the latent image bearing member;
adjusting the adjusting inclination based on the ratio to prevent the scan line from being inclined relative to the reference scan line; and
initiating scanning of the surface of the latent image bearing member by the light beam after adjustment of inclination and after the rotary deflector starts rotating at a constant speed for writing the latent image on the surface of the latent image bearing member.
